(19) United States
(12) Patent Application Publication
(10) Pub. No.: US 2006/0203281 A1
(43) Pub. Date: Sep. 14, 2006

(54) Multi-function device with user selectable copy and scan mode

(75) Inventors: Brian D. Cook, Nicholasville, KY (US); Mark J. Edwards, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/075,143

(22) Filed: Mar. 8, 2005

(51) Int. Cl. G06F 3/12

(52) U.S. Cl. 358/1.15

(57) ABSTRACT

A multi-function device and a method of operation are described, wherein the multi-function device includes a scanner, a printer, and a controller. The controller is operable to communicate with the scanner, the printer, and a second device, operable to convert scanned image data to electronic data in the printer format, and operable to convert scanned image data to electronic data in a standard format readable by the second device. The controller is also responsive to a user control communicating with the controller for implementing a copy and scan mode, wherein while in the copy and scan mode, the scanner performs a single scanning operation for each page of a desired original to produce scanned image data representing the desired original. The controller converts the scanned image data to electronic data in a printer format and to electronic data in a standard format, and transmits the printer formatted electronic data to the printer and the standard formatted electronic data to the second device. The printer prints a hard copy of each page of the desired original.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to a multi-function device, and in particular, to a multi-function device having a user selectable mode providing both copy and scan functions to produce a hard copy of an original and to transmit electronic data representative of the original.

2. Description of the Related Art

A multi-function device (MFD), also known as a multi-function printer (MFP) or an All-in-One (AIO), typically includes a printer and a scanner. Such a device can be configured as a stand-alone device, or can be coupled to a host computer or a network. An MFD is typically operable to perform several different functions such as copying, scanning, and printing.

The scanner of an MFD uses sensors to produce scanned image data representing an original. As used herein, an original refers to a document, a picture, or the like, comprising one or multiple pages. The scanned image data is essentially an electronic copy of the original and can exist in a variety of forms.

Typically, MFDs are operable in several modes. In a copy mode, an original is scanned by the scanner and electronic data representative of the original is transmitted to the printer to print a hard copy of the original. In a scan mode, an original is scanned by the scanner and then electronic data is transmitted to the host computer or another device for display, manipulation, or storage. In a printing mode, an electronic image file is received from a host computer or other device such as, for example, a digital camera or memory card, and printed to produce a hard copy of a desired image. Because both electronic mail (e-mail) and facsimile (fax) are common methods of communication in today's computerized world, MFDs also often include selectable modes such as scan to e-mail or scan to fax, wherein electronic data representative of an original can be sent via e-mail over a network or via fax over a phone line to a recipient.

### SUMMARY OF THE INVENTION

A typical prior art multi-function device includes separate copy and scan modes such that two separate scanning operations are necessary to produce a hard copy of an original and also transmit electronic data to another device such as a host computer. It is desirable to have a user selectable mode that combines both the copy mode and the scan mode in order to simplify the operation of a multi-function device when both copy and scan operations are desired. A combined copy and scan mode is also advantageous in that only a single scanning operation is required for both copying and scanning.

In one aspect, the invention provides a multi-function device including a scanner, a printer and a controller. The scanner is operable to scan an original and produce scanned image data. The printer is operable to receive electronic data representing a desired image in a printer format and print a hard copy of the desired image. The controller is operable to communicate with the scanner, the printer, and a second device, is operable to convert scanned image data to electronic data in the printer format and to convert scanned image data to electronic data in a standard format readable by the second device. The controller is responsive to a user control communicating with the controller to implement a copy and scan mode. In the copy and scan mode, the scanner performs a single scanning operation of each page of a desired original to produce scanned image data representing the desired original, the controller converts the scanned image data to electronic data in the printer format and to electronic data in the standard format, the printer receives the electronic data in a printer format and prints a hard copy of the desired original, and the controller transmits the electronic data in the standard format to the second device.

In another aspect the invention provides a method for operating a multi-function device, wherein the multi-function device includes a scanner, a printer, a user activated control, and a controller in communication with each of the foregoing. The method comprises activating a copy and scan mode via the user activated control; and while in the copy and scan mode, sequentially scanning via the scanner each page of a desired original to produce scanned image data, converting the scanned image data to electronic data into a printer format and a standard format, printing via the printer a hard copy of the original using the electronic data in the printer format; and transmitting the electronic data in the standard format to a second device in communication with the multifunction device.

### BRIEF DESCRIPTION OF THE DRAWING

FIG. 1 is a schematic illustration of one embodiment of a multi-function device incorporating the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

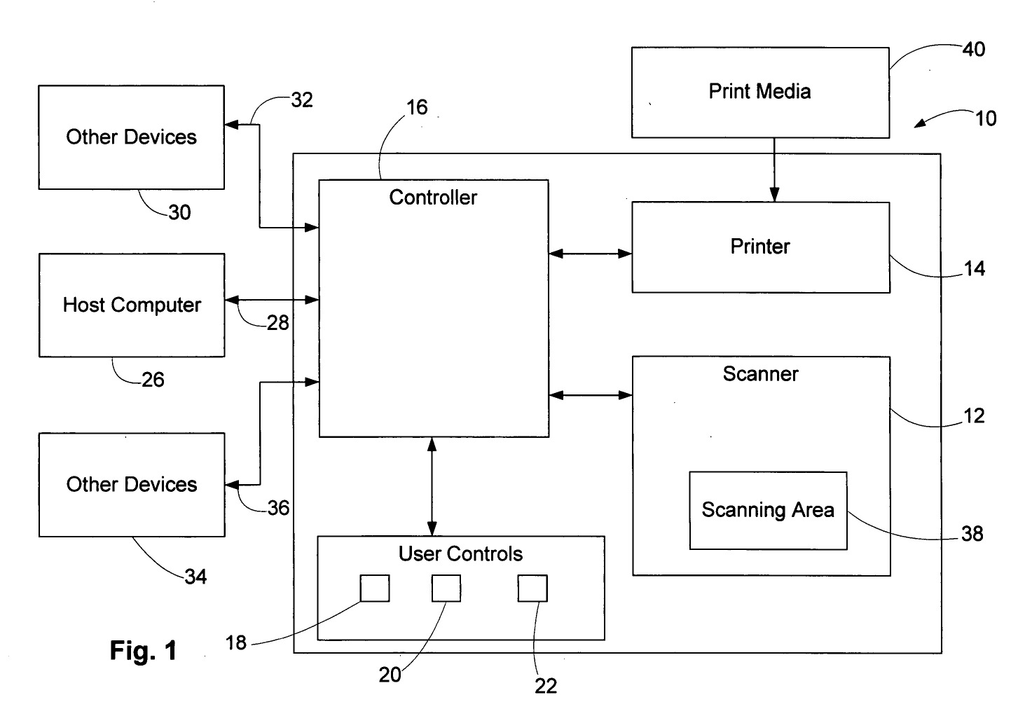

FIG. 1 schematically illustrates one embodiment of a multi-function device 10. In particular, multi-function device 10 includes a scanner 12, a printer 14, a controller 16, and a plurality of user controls 18, 20, 22. In the illustrated embodiment, the multi-function device 10 is operable to communicate with a host computer 26 via a link 28, and is operable to communicate with one or more other devices 30 via a network 32, and one or more other devices 34 via phone lines 36. In other embodiments, the multi-function device 10 is operable to communicate with a single other device, or other combinations of devices. These devices include facsimile machines, personal digital assistants or PDAs, and electronic memory devices and other devices capable of storing and/or displaying the standard formatted electronic data. Further, in other embodiments, certain user controls can also be made available as part of a software application on the host computer 26, in order to control the operation of the multi-function device 10 from the host computer 26.

The scanner 12 includes a scanning area 38 on which an original can be placed either manually or automatically by being sequentially fed from a storage unit (not shown) under the control of the controller 16. For example, if the original includes multiple pages (sheets), an automatic feeder function (not shown) of the device 10 sequentially feeds the pages to the scanning area 38. Different types of scanners are known in the art and include, for example, scanners including optical reduction devices employing charge coupled device (CCD) sensor technology or scanners including contact image sensor (CIS) technology. Such scanners move relative to each page of an original to generate scanned image data or conversely the original moves relative to such scanners. A single scanning operation may require a single pass or multiple passes with respect to each page, depending on the type of sensor utilized in the scanner. An illumination system (not shown) provides proper light such that the sensors can obtain accurate readings of the original. The scanned image data represents the original.

The printer 14 is operable to receive electronic data representing a desired image and print a hard copy of that desired image on a print medium 40, such as a sheet of paper. For example, the printer 14 communicates with the controller 16, and can receive electronic data in a printer format from the controller 16 and instructions that cause the printer to print in a desired manner, as is known in the art.

The controller 16 is operable to communicate with the scanner 12, the printer 14, and a second device. For example, in the illustrated embodiment, the second device may be the host computer 26, or other devices 30 or 34 communicating with the controller 16 via a network 32 or phone lines 36. The network can be wired, wireless or a combination of both. The controller 16 is also operable to convert scanned image data from the scanner 12 into electronic data in the printer format. Further, the controller 16 is operable to convert scanned image data from the scanner 12 into electronic data in a standard format readable by the second device.

For example, when the second device is a host computer 26, or another computer, or device such as a printer, one standard format for the electronic data is an image file in the portable document format (PDF). PDF is the file format for representing documents and pictures in a manner that is independent of the application software, hardware, and operating system that are used to create those documents or pictures. A PDF file can describe documents and pictures containing any combination of text, graphics, and images in a device-independent and resolution independent format, and representing one or more pages. Other standard formats, such as bitmaps, TIFF and JPEG, readable by a second device also exist. The standard format can be predetermined or selected by multifunction device or may be selected by the user at the time that the copy and scan mode is selected.

The hardware and software for configuring controller 16 to perform these conversions is known to one skilled in the art.

The multi-function device 10 is operable in one of several different modes, wherein one mode is a copy and scan mode, as further described below.

In one embodiment, the user controls 18, 20, and 22 are each associated with the different modes of operation of the multi-function device 10, and communicate with the controller 16. The controller 16 is responsive to the user controls 18, 20, 22. For example, activating user control 18 will initiate a copy mode. Activating user control 20 will initiate a scan mode. Activating user control 22 will initiate a copy and scan mode. In this embodiment, the user controls are push buttons, or touch screen selections or the like, so that a copy and scan mode can be initiated with a single activation step.

In the copy mode, the scanner 12 sequentially scans each page of a desired original to produce scanned image data representing the desired original, and the controller 16 converts the scanned image data to electronic data in the printer format. The controller 16 transmits the electronic data in the printer format to the printer 14, and the printer 14 prints a hard copy of each page of the desired original. In the copy mode, the scanned image data is not converted into the standard format and is not saved.

In the scan mode, the scanner 12 scans each page of a desired original to produce scanned image data representing the desired original, and the controller 16 converts the scanned image data to electronic data in the standard format, such as PDF, including one or more files for each page. The controller 16 transmits the electronic data in the standard format to a second device, such as the host computer 26. In this mode, the scanned image data is not converted into electronic data in the printer format and no hard copies of the original are printed.

In the copy and scan mode, the scanner 12 scans each page of a desired original to produce scanned image data representing the desired original. Only a single scanning operation is performed for each page of the original. The controller 16 converts the scanned image data to electronic data in a printer format and to electronic data in the standard format. The controller 16 then transmits to the printer 14 the electronic data in the printer format and the printer 14 prints a hard copy of each page of the desired original. The controller 16 also transmits the electronic data in the standard format to the second device. For example, if the second device is the host computer 26, the host computer 26 can then save this electronic data.

The electronic data in the standard format can be transmitted as a single file that includes all pages of the original or as multiple files each including a selected number of pages of the original.

In one embodiment, the multifunction device 10 is connected to a host computer 26, and the host computer 26 includes application software for control of the multi-function device 10. In such a case, the controller 16 operates to convert each page of an original into a displayable file, with thumbnail sketches of each file then displayable at the host computer 26. The application software can be configured so as to allow a user to select one or more of the thumbnail sketches as a group. Such a group can then be configured as a single file, stored at the host computer 26, or attached to one or more e-mails to be sent to one or more recipients.

This copy and scan mode is advantageous because only one scanning operation is performed to implement copy and scan functions, thereby saving time and saving energy related to operation of the multi-function device 10, including energy savings related to providing illumination for the scanning operation.

The implementation of a user control to activate a copy and scan mode can take various forms. For example, there may not be separate controls to implement both the copy mode and the copy and scan mode. In one embodiment, a user control, when activated, would initiate the copy and scan mode when a host computer 26 or other device capable of receiving the standard formatted electronic data is connected (as determined by the controller 16), and would initiate a copy only mode, wherein a hard copy of the original is printed out, otherwise. In another implementation, when a user control is activated, this would initiate a user dialog to query whether the user wants to operate in the copy mode or in the copy and scan mode. In such a case, the activation of the copy and scan mode requires more than one activation step performed by a user. In another implementation, when the multi-function device 10 is initially configured for operation with a host computer 26, a user can select which modes of operation are desired.

The foregoing description of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A multi-function device, comprising:
a scanner operable to scan an original and produce scanned image data;
a printer operable to receive electronic data representing a desired image in a printer format and print a hard copy of the desired image; and
a controller operable to communicate with the scanner, the printer, and a second device, operable to convert scanned image data to electronic data in the printer format, operable to convert scanned image data to electronic data in a standard format readable by the second device, and responsive to a user control communicating with the controller for implementing a copy and scan mode, wherein while in the copy and scan mode, the scanner performs a single scanning operation for each page of a desired original to produce scanned image data representing the desired original, the controller converts the scanned image data to electronic data in the printer format, the controller converts the scanned image data to electronic data in the standard format, the controller transmits the printer formatted electronic data to the printer, the printer prints a hard copy of the desired original, and the controller transmits the standard formatted electronic data to the second device.

2. The multi-function device of claim 1, wherein implementing a copy and scan mode requires a single activation step.

3. The multi-function device of claim 1, wherein implementing a copy and scan mode requires multiple activation steps.

4. The multi-function device of claim 1, wherein the second device is one of a host computer, a facsimile machine, a PDA device, and an electronic memory device.

5. The multi-function device of claim 1, wherein the standard formatted electronic data is transmitted to the second device via one of a network, email, and telephone lines.

6. The multi-function device of claim 1, wherein the standard formatted electronic data includes one or more data files, each data file corresponding to one or more pages of the original.

7. A multi-function device, comprising:
a scanner operable to scan an original and produce scanned image data representing the original;
a printer operable to receive electronic data representing a desired image in a printer format and print a hard copy of the desired image;
a controller operable to communicate with the scanner, the printer, and a host computer, the controller operable to convert the scanned image data to an electronic data in the printer format and operable to convert the scanned image data to electronic data in a standard format readable by the host computer; and
a user control communicating with the controller for implementing a copy and scan mode, wherein in the copy and scan mode, the scanner performs a single scanning operation for each page of a desired original to produce scanned image data representing the desired original, the controller converts the scanned image data to electronic data in a printer format, the controller converts the scanned image data to electronic data in a standard format, the printer then receives the printer formatted electronic data and prints a hard copy of each page of the desired original, and the controller transmits the electronic data in the standard format to the host computer.

8. The multi-function device of claim 7, wherein activation of the user control requires one or more activation steps.

9. The multi-function device of claim 7, wherein the standard formatted electronic data includes one or more data files, each data file corresponding to one or more pages of the original.

10. The multi-function device of claim 7, wherein the standard formatted electronic data comprises one or more PDF files.

11. A method for operating a multi-function device, wherein the multi-function device includes a scanner, a printer, a user activated control, and a controller in communication with each of the foregoing, the method comprising:
activating a copy and scan mode via the user activated control; and
while in the copy and scan mode:
sequentially scanning via the scanner each page of a desired original to produce scanned image data;
converting the scanned image data to electronic data into a printer format and a standard format;
printing via the printer a hard copy of the original using the electronic data in the printer format; and
transmitting the electronic data in the standard format to a second device in communication with the multifunction device.

12. The method of claim 11, wherein the standard formatted electronic data is transmitted to the second device via one of a network, email, and telephone lines.

13. The method of claim 11, wherein the second device is one of a host computer, a facsimile machine, a PDA device, and an electronic memory device and the method further comprises storing the standard formatted electronic data in the second device.

14. The method of claim 11, wherein the electronic data in the standard format comprises one or more files each representing one or more pages of the desired original.

15. The method of claim 14, wherein one of files contains a thumbnail image of one or more pages of the original.

16. The method of claim 11, wherein the electronic data in the standard format for converting the scanned image data is chosen from PDF format, a JPEG format, a TIFF format and a bitmap format.

17. The method of claim 11, wherein activating a copy and scan mode further comprises selecting the standard format to be used for the converted scanned image data to be sent to the second device from a plurality of standard formats.

18. The method of claim 17, wherein the standard format to be used for the converted scanned image data to be sent to the second device is selected by a user.

19. The method of claim 17, wherein the standard format to be used for the converted scanned image data to be sent to the second device is selected by the multifunction device.

20. The method of claim 11, further comprising after activating the copy and scan mode determining if a second device capable of receiving the standard formatted image data is in communication with the multifunction device and on determining that no second device is in communication with the multifunction device performing a copy only function.
